(19) United States
(12) Patent Application Publication
(10) Pub. No.: US 2009/0128497 A1
(43) Pub. Date: May 21, 2009

(54) Portable Electronic Device and its Key structure

(75) Inventors: Ko-Min Wang, Taoyuan City (TW); I-Cheng Chuang, Taoyuan City (TW); Yu-Jing Liao, Taoyuan City (TW); Chia-Hsiung Peng, Taoyuan City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: HTC Corporation, Taoyuan City (TW)

(21) Appl. No.: 12/197,359

(22) Filed: Aug. 25, 2008

(30) Foreign Application Priority Data
Nov. 20, 2007 (TW) 096143851

(51) Int. Cl. G06F 3/02

(52) U.S. Cl. 345/170

(57) ABSTRACT

A key structure of a portable electronic device is provided. The portable electronic device has a first operation mode and a second operation mode. The key structure comprises a key, a first light source, and a second light source. The first light source emits a first colored light in the first operation mode so that the key can display a first input symbol. The second light source emits a second colored light in the first operation mode so that the key can display a second input symbol. As a result, users who operate portable electronic devices with the aforementioned key structure can easily recognize the different kinds of input symbols corresponding to different input methods in different operation modes.

This application claims priority to Taiwan Patent Application No. 096143851 filed on Nov. 20, 2007, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention provides a key structure for a portable electronic device and such a portable electronic device, and particularly, relates to a key structure is capable of displaying different kinds of input symbols corresponding to different input methods in response to different operation modes and a portable electronic device with such a key structure.

2. Descriptions of the Related Art

Currently, various portable electronic devices are becoming increasingly popular. To promote the competitiveness of their products, manufacturers are developing a wide variety of multi-functional intelligent portable electronic devices. Because such portable electronic devices are getting more diversified in function, the amount of input data is also increasing.

Generally, symbols corresponding to the various input methods such as numerals, phonetic notations, English letters, punctuation marks, Cangjie radicals or the like are inputted into a portable electronic device via keys. For instance, in a normal mode, the keys primarily provide the numeral functions for the user to input a phone number for calls. On the other hand, when the user desires to input a short message or store a contact name corresponding to a phone number, or even use Personal Digital Assistant (PDA) functions, the input method has to be switched to other modes. Since each key represents different kinds of input symbols corresponding to different input methods, symbols corresponding to the different input methods are printed thereon. Hence, when the user switches between the different modes, it will be difficult to quickly find the desired key corresponding to the input method currently used, thus causing confusion. Therefore, it is highly desirable in the art to provide a solution that can highlight symbols corresponding to the desired input method in different input modes.

More specifically, FIG. 1 depicts a cross-sectional view of a conventional key structure 1 for the keypad of a portable electronic device. The conventional key structure 1 includes a key 11, a supporting structure 12, a plurality of light-emitting diode (LED) light sources 13, a dome sheet 14 and a printed circuit board (PCB) 15. The key 11 is disposed on the supporting structure 12, which in turn is disposed on the dome sheet 14 and the LED light sources 13. The dome sheet 14 and the LED light sources 13 are bonded to the PCB 15 underneath. The dome sheet 14 further includes a dome switch 141. When a user presses down the key 11, a protrusion 121 of the supporting structure 12 will force the dome switch 141 of the dome sheet 14 to contact an electrical contact on the PCB 15, thereby accomplishing the key-pressing action.

As seen from FIG. 1, the LED light sources 13 of the conventional key structure 1 are disposed on both sides of the dome switch 141 so that the colored light emitted from the LED light sources 13 have to obliquely be transmitted through the supporting structure 12 before exiting from the surface of the key 11. Consequently, it is impossible for the colored light to exit uniformly from the key 11. Furthermore, because the LED light sources 13 can only emit light of a single color, it is difficult for a user to recognize the desired input symbol when the key 11 displays different kinds of input symbols corresponding to different input methods.

### SUMMARY OF THE INVENTION

This invention provides a key structure for a portable electronic device, which enables a user to quickly recognize a desired input symbol. The portable electronic device has a first operation mode and a second operation mode. The key structure includes a key, a first light source and a second light source. The key is configured to display a first input symbol and a second input symbol. The first light source and the second light source are disposed under the key respectively, and configured to emit a first colored light and a second colored light to light up the first input symbol and the second input symbol in specific operation modes respectively.

This invention also provides a portable electronic device with a first and a second body status. The portable electronic device includes an upper body and a lower body, in which the lower body further includes a plurality of the aforesaid key structures. The portable electronic device is configured to operate in a first operation mode under the first body status, and operate in a second operation mode under the second body status. The plurality of key structures are able to emit a first colored light and a second colored light respectively in response to the different operation modes to display the first input symbol and the second input symbol respectively.

By means of the key structure capable of displaying different colored lights or emitting light only in a single area in response to the different operation modes of the portable electronic device. This invention enables the user to more clearly recognize the desired key to be pressed, thus making the portable electronic device easier to operate.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional view of a conventional key structure;

FIG. 2A illustrates the first body status of a portable electronic device in accordance with the first embodiment of this invention;

FIG. 2B illustrates the second body status of the portable electronic device in accordance with the first embodiment of this invention;

FIG. 3A is a cross-sectional view of a key structure in accordance with the first embodiment of this invention;

FIG. 3B is a top view of a key in accordance with the first embodiment of this invention;

FIG. 3C is a cross-sectional view of another example of the key structure in accordance with the first embodiment of this invention;

FIG. 3D is a schematic view of the key structure shown in FIG. 3C;

FIG. 4A is a cross-sectional view of a key structure in accordance with the second embodiment of this invention;

FIG. 4B is a top view of a key in accordance with the second embodiment of this invention; and

FIG. 5 is a top view of a key in accordance with a third embodiment of this invention.

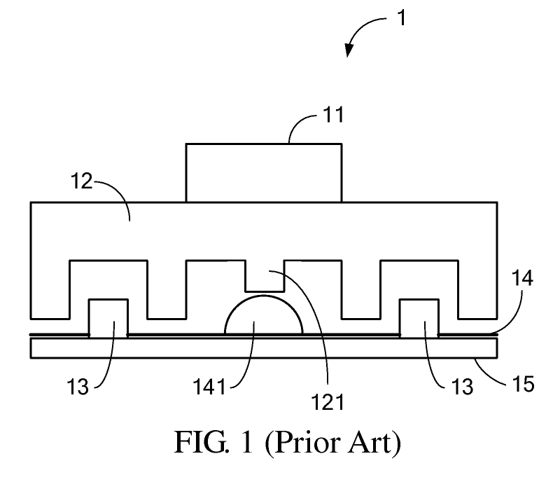

### DESCRIPTION OF THE PREFERRED EMBODIMENT

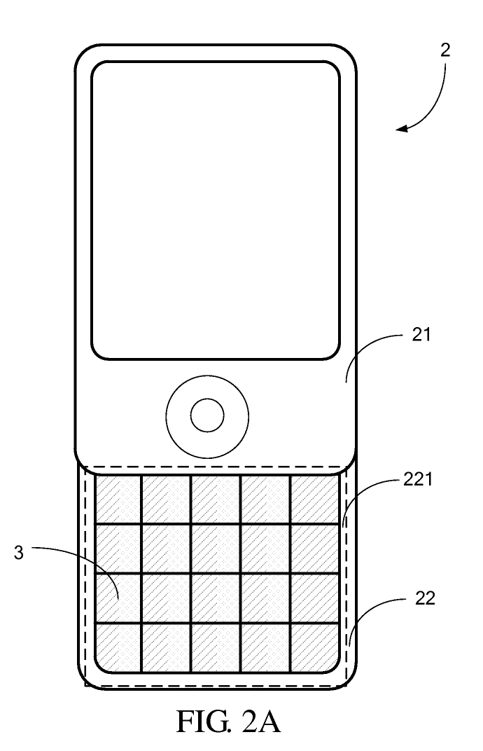

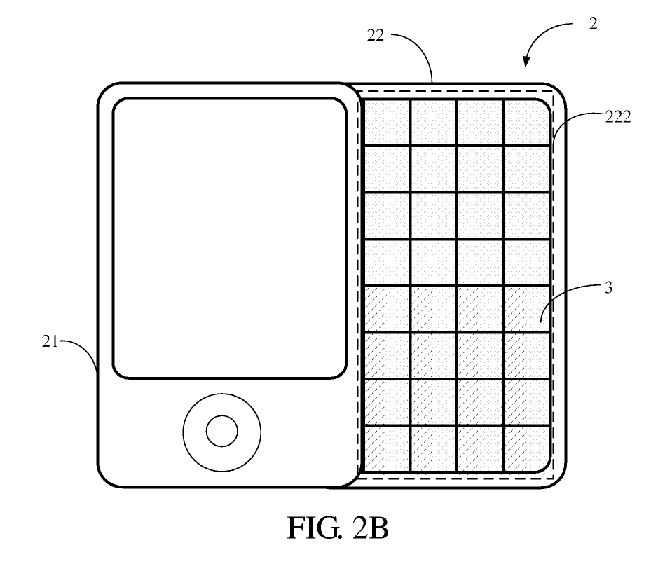

As depicted in FIGS. 2A and 2B, the first embodiment of this invention is a portable electronic device 2. In this embodiment, the portable electronic device 2 is a dual sliding mobile phone.

The portable electronic device 2 of this embodiment includes an upper body 21 and a lower body 22 substantially connected to the upper body 21. A keypad on the lower body 22 includes a plurality of key structures 3. When the upper body 21 and the lower body 22 of the portable electronic device 2 are opened up along a first direction, i.e., the upper body 21 is pushed upwards to take on a first body status as depicted in FIG. 2A, the portable electronic device 2 operates in a first operation mode. Alternatively, when the upper body 21 and the lower body 22 of the portable electronic device 2 are opened up along a second direction, i.e., the upper body 21 is pushed leftwards to take on a second body status as depicted in FIG. 2B, the portable electronic device 2 operates in a second operation mode. In this embodiment, the first direction and the second direction are substantially perpendicular to each other. However, in other embodiments, the first direction and the second direction may include other angles. Furthermore, the portable electronic device 2 of this embodiment switches between the operation modes by pushing the upper body 21. However, in other embodiments, the operation modes may be switched by flipping up or rotating the upper body or by means of a switching key in the keypad.

In this embodiment, the upper body 21 and the lower body 22 of the portable electronic device 2 are usually folded together. When operating in the first operating mode, however, the upper body 21 and the lower body 22 take on the first body status as depicted in FIG. 2A, in which case only a first set 221 of the key structures 3 is exposed. Because most of the key structures 3 in the first set 221 provide a numeral symbol respectively, the key structures 3 in the first set 221 are used in the first operation mode to input numeral symbols, i.e., to dial or store a phone number. In other words, the first operation mode may be a telephone mode. On the other hand, when the portable electronic device 2 operates in the second operating mode, the upper body 21 and the lower body 22 take on the second body status as depicted in FIG. 2B, in which case a second set 222 of the key structures 3 is exposed. Because most of the key structures 3 in the second set 222 provide two or more symbols (for example, a phonetic notation and an English letter) respectively to allow use of two or more input methods, the key structures 3 in the second set 222 are used in the second operation mode to input phonetic notations and English letters for purpose of editing messages, contact information or memos. In other words, the second operation mode may be a text input mode. It should be noted that some of the key structures in the first set 221 may be overlapped with those in the second set 222. The English letter keys in the second set 222 are arranged roughly in the conventional QWERTY style.

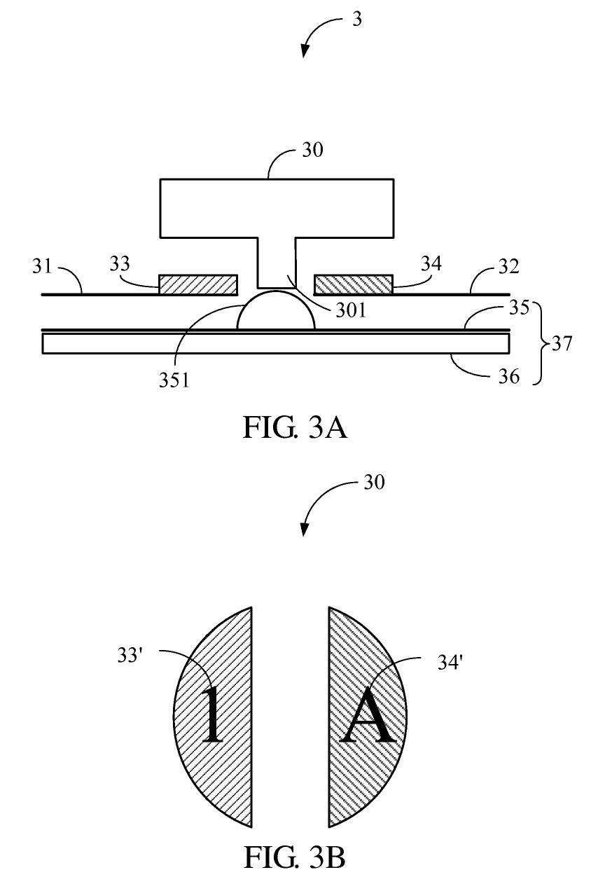

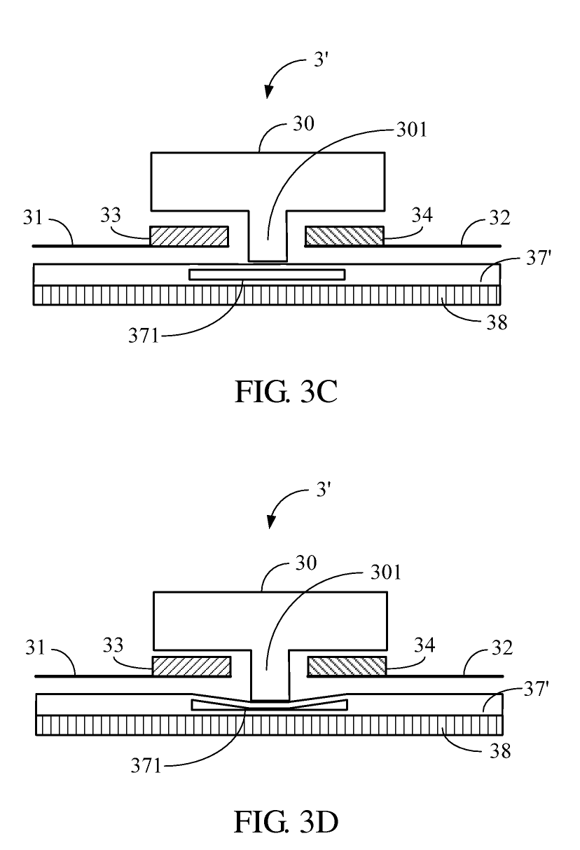

The keypad of the portable electronic device 2 includes a plurality of key structures 3, each of which has a cross-sectional view as depicted in FIG. 3A. The key structure 3 includes a key 30, a first light source 31, a second light source 32 and a switch sheet 37. In this embodiment, the switch sheet 37 includes a dome sheet 35 and a circuit board 36. In this embodiment, the circuit board 36 is a printed circuit board (PCB). A top view of the key 30 is depicted in FIG. 3B. As can be seen, the key 30 is disposed above the first light source 31 and the second light source 32, while the dome sheet 35 and the circuit board 36 of the switch sheet 37 are disposed sequentially under the first light source 31 and the second light source 32. In other embodiments, when the key 30 is provided with a touch sensing function, the switch sheet 37 may be omitted from the key structure 3.

In this embodiment, the key 30 has a protrusion 301 adapted to press a dome switch 351 of the dome sheet 35 of the switch sheet 37. Additionally, the key 30 is further adapted to display a first input symbol 33′ and a second input symbol 34′, as depicted in FIG. 3B. Here, the first input symbol 33′ is a numeral while the second input symbol 34′ is an English letter. In other embodiments, the first input symbol 33′ may be either an English letter, a phonetic notation, a punctuation mark or a sign, while the second input symbol 34′ may either be a numeral, an English letter, a phonetic notation, a punctuation mark or a sign that is different from the first input symbol 33′.

Preferably, the key 30 of this embodiment should have a mirror surface (but is not just limited thereto), which is formed by a physical vapor deposition (PVD) process, and more specifically, by a non-conductive vacuum metallization (NCVM) process.

The first light source 31 and the second light source 32 are configured to emit a first colored light and a second colored light respectively. In this embodiment, the first colored light is significantly distinct from the second colored light. Additionally, both the first light source 31 and the second light source 32 in this embodiment is an electro-luminescence film (EL film). However, in other embodiments, either or both the first light source 31 and the second light source 32 may adopt other known, sheet-like or plate-like light sources, such as an organic electro-luminescence film (OEL film).

In this embodiment, the first light source 31 and the second light source 32 have a first pattern 33 corresponding to the first input symbol 33′ and a second pattern 34 corresponding to the second input symbol 34′ respectively. More specifically, when the first light source 31 and the second light source 32 are each an EL film or an OEL film, the first pattern 33 and the second pattern 34 can be formed by a patterning process.

As shown in FIGS. 2A, 3A and 3B, when a user pushes the upper body 21 overlapped with the lower body 22 upwards (or pushes the lower body 22 downwards) until the upper body 21 and the lower body 22 take on the first body status, the portable electronic device 2 will operate in the aforesaid first operation mode, in which case the first pattern 33 of the first light source 31 emits the first colored light. Consequently, the key 30 displays the first input symbol 33′ with the first colored light. In addition, when the user pushes the upper body 21 overlapped with the lower body 22 leftwards (or pushes the lower body 22 rightwards), until the lower body 22 take on the second body status, the portable electronic device 2 will operate in the aforesaid second operation mode, in which case the second pattern 34 of the second light source 32 emits the second colored light. Consequently, the key 30 displays the second input symbol 34′ with the second colored light.

Therefore, with the key structure 3 of this invention, the user is able to recognize the first input symbol 33′ or the second input symbol 34′ highlighted by the particular colored light indicating each of the different operation modes, and can then select the key 30 to press. When the key 30 is pressed, the protrusion 301 thereof presses against the dome switch 351 of the dome sheet 35 to contact an electrical contact on the circuit board 36, thereby accomplishing the key-pressing action.

It should be noted that the relationships between the operation modes and different colored lights in this invention are not just limited to what has been mentioned so far. For example, the first input symbol always emits the first colored light while the second input symbol always emits the second colored light, regardless of the operation mode. In another example, the color of the first colored light is identical to that of the second colored light and only the first input symbol is lit up in the first operation mode, while the second input symbol is lit up only in the second operation mode.

Another example of the switch sheet 37 of the key structure 3 in accordance with the first embodiment of this invention is depicted in FIG. 3C. In this example, the key structure 3′ includes a key 30, a first light source 31, a second light source 32, a switch sheet 37′ and a supporting sheet 38. The switch sheet 37′ has a switch 371 corresponding to the protrusion 301 of the key 30. In this example, the switch sheet 37′ is a membrane circuit sheet adapted to replace the dome sheet 35 and the circuit board 36 of the first embodiment. The switch 371 of the switch sheet 37′ is formed by separating an upper electrical contact and a lower electrical contact. In this sense, the switch 371 corresponds to the dome switch 351 of the dome sheet 35 and the circuit board 36 of the first embodiment. As depicted in FIG. 3D, when the key 30 is pressed, the protrusion 301 of the key 30 will press against the switch 371 to electrically connect the upper electrical contact to the lower electrical contact, thus accomplishing the key-pressing action.

Furthermore, if the switch sheet 37′ is a membrane circuit sheet, a supporting sheet 38 may be further added under the switch sheet 37′ to avoid the warping of the switch sheet 37′. In this example, other elements of the key structure 3′ are just the same as those of the first embodiment, and thus will not be further described herein. Because the switch sheet 37′ of this example is adapted to provide the same function as that of the dome sheet and the circuit board, the switch sheet 37′ may also be applied in key structures of other embodiments, rather than just be limited to the application and arrangements described above.

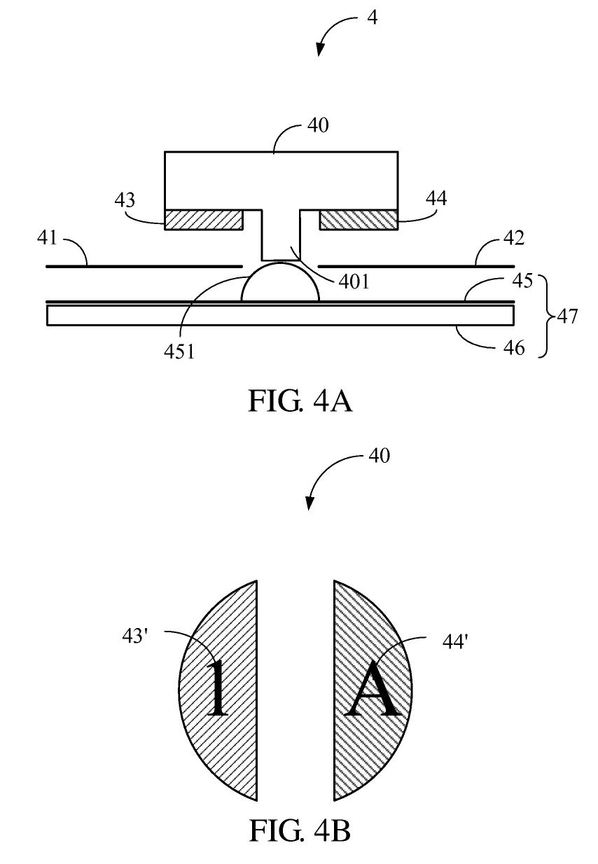

The second embodiment of this invention differs from the first embodiment in that the portable electronic device of this embodiment adopts a different key structure 4, a cross-sectional view of which is depicted in FIG. 4A. Like the key structure 3 of the first embodiment, the key structure 4 also includes a key 40, a first light source 41, a second light source 42 and a switch sheet 47. The key 40 has a protrusion 401. The switch sheet 47 includes a dome sheet 45 and a circuit board 46, in which the dome sheet 45 further comprises a dome switch 451. The difference from the key structure 3 of the first embodiment is that, the key 40 in the key structure 4 of this embodiment has a third pattern 43 and a fourth pattern 44, which are printed on the bottom surface of the key 40 and correspond to the first input symbol 43′ and the second input symbol 44′ respectively, as shown by the top view in FIG. 4B. In other embodiments, the third pattern 43 and the fourth pattern 44 may also be formed on the top surface of the key 40.

In the first embodiment, the first pattern 33 and the second pattern 34 corresponding to the first input symbol 33′ and the second input symbol 34′ respectively are formed by patterning an EL film or an OEL film. However, in this embodiment, the third pattern 43 and the fourth pattern 44 corresponding to the first input symbol 43′ and the second input symbol 44′ respectively are formed on the bottom surface of the key 40. Other structures of this embodiment and operations thereof are much the same as those of the first embodiment, and thus will not be further described herein.

The key structure of this embodiment is further able to display a third input symbol to cater the users' need. The portable electronic device adopting such a key structure further has a third operation mode. Additionally, switching between the different operation modes may be accomplished through relative movement of the two bodies, or by means of a switching key in the keypad.

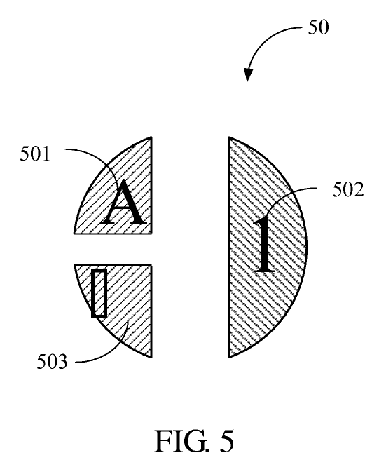

More specifically, the key structure of this embodiment further includes a third light source (not shown) emitting a third colored light. Accordingly, the key structure 50 is adapted to display a third input symbol 503, as depicted by the top view illustrated in FIG. 5. In this embodiment, the first input symbol 501 is an English letter, the second input symbol 502 is a numeral, and the third input symbol 503 is a phonetic notation. However, in other examples, the first input symbol 501, the second input symbol 502 and the third input symbol 503 are all selected from a group consisting of a numeral, an English letter, a phonetic notation, a punctuation mark or a sign, and are different from each other.

In this embodiment, the first colored light, the second colored light and the third colored light each have a different color, and are lit up in the respective operation modes. However, in other examples, they can be lit up simultaneously, or alternatively, the first colored light, the second colored light and the third colored light may have the same color and are lit up in the respective operation mode. In this embodiment, the EL films are used for the first light source, the second light source and the third light source. However, in other examples, other light sources, sheet-like or plate-like light sources (e.g. an OEL film) may be used instead.

In this embodiment, the first light source, the second light source and the third light source are formed respectively with a first pattern, a second pattern and a fifth pattern, which correspond to the first input symbol 501, the second input symbol 502 and the third input symbol 503 to be displayed by the key 50 respectively. However, in other examples, the fifth pattern corresponding to the third input symbol 503 may also be formed on the bottom surface of the key 50, which is similar to what is depicted in FIG. 4A. Furthermore, the switch sheet 37′ depicted in FIG. 3C and FIG. 3D can also be applied in this embodiment.

The portable electronic device described in the above embodiments are not just limited to dual sliding mobile phones or even mobile phones, but may be applied to any portable electronic devices with a key structure that allows a user to input symbols corresponding to two or more input methods. This also falls within the scope of this invention. Moreover, in a mobile phone, this portable electronic device is also not just limited to the upward-sliding or leftward-sliding style, but may have a bar style, a clamshell/flip style, a downward-sliding or rightward-sliding style, a swivel style or the like. Furthermore, other types and numbers of operation modes, light sources, colored lights, input symbols and patterns will readily occur to those skilled in the art upon reviewing the above embodiments. For example, the number of light sources or the patterns may vary according to the operation modes or the types of input symbols. Therefore, this will not be further described herein. Those skilled in the art may also readily apply other kinds of switch sheets to the key structure of this invention, and all these modifications or equivalents thereof still fall within the scope of this invention.

The key structures according to the above embodiments are capable of uniformly emitting light of two or more different (or identical) colors simultaneously (or respectively), and obviously displaying different kinds of input symbols corresponding to different input methods. Because the key is able to display different kinds of input symbols in different operation modes correspondingly, it is more convenient for the user to choose the desired input symbols of a specific input method, adding operability to the portable electronic device.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A key structure, adapted for a portable electronic device having a first operation mode and a second operation mode, the key structure comprising:
a key configured to display a first input symbol and a second input symbol;
a first light source, disposed under the key, and emitting a first colored light in the first operation mode to light up the first input symbol; and
a second light source, disposed under the key, emitting a second colored light in the second operation mode to light up the second input symbol.

2. The key structure as claimed in claim 1, further comprising a switch sheet disposed under the first light source and the second light source, wherein the key comprises a protrusion adapted to press the switch sheet.

3. The key structure as claimed in claim 2, wherein the switch sheet comprises:
a dome sheet, disposed under the first light source and the second light source, comprising a dome switch corresponding to the key, wherein the protrusion is adapted to press the dome switch; and
a circuit board disposed under the dome sheet.

4. The key structure as claimed in claim 2, further comprising a supporting sheet, wherein the switch sheet is disposed on the supporting sheet and is a membrane circuit sheet.

5. The key structure as claimed in claim 1, wherein the first light source has a first pattern corresponding to the first input symbol, and the second light source has a second pattern corresponding to the second input symbol.

6. The key structure as claimed in claim 1, wherein the key has a third pattern, a fourth pattern and a bottom, and the third pattern and the fourth pattern, corresponding to the first input symbol and the second input symbol, respectively, are disposed on the bottom.

7. The key structure as claimed in claim 1, wherein the color of the first colored light is different from the color of the second colored light.

8. The key structure as claimed in claim 1, wherein the first input symbol is one of a numeral, an English letter, a phonetic notation, a punctuation mark, and a sign, the second input symbol is one of a numeral, an English letter, a phonetic notation, a punctuation mark, and a sign, and the first input symbol is different from the second input symbol.

9. The key structure as claimed in claim 1, wherein each of the first light source and the second light source is one of an Electro-luminescence film (EL) or an Organic Electro-luminescence (OEL) film.

10. A portable electronic device having a first body status and a second body status corresponding to a first operation mode and a second operation mode of the portable electronic device respectively, the portable electronic device comprising:
an upper body; and
a lower body, connected to the upper body substantially, comprising a plurality of key structures, wherein each of the key structures comprises:
a key configured to display a first input symbol and a second input symbol;
a first light source, disposed under the key, and emitting a first colored light in the first operation mode to light up the first input symbol; and
a second light source, disposed under the key, and emitting a second colored light in the second operation mode to light up the second input symbol.

11. The portable electronic device as claimed in claim 10, wherein each of the key structures further comprises a switch sheet disposed under the first light source and the second light source, and the key comprises a protrusion adapted to press the switch sheet.

12. The portable electronic device as claimed in claim 11, wherein the switch sheet comprises:
a dome sheet, disposed under the first light source and the second light source, comprising a dome switch corresponding to the key, wherein the protrusion is adapted to press the dome switch; and
a circuit board disposed under the dome sheet.

13. The portable electronic device as claimed in claim 11, further comprising a supporting sheet, wherein the switch sheet is disposed on the supporting sheet and is a membrane circuit sheet.

14. The portable electronic device as claimed in claim 10, wherein the upper body and the lower body are opened up along a first direction to take on the first body status in the first operation mode, and the upper body and the lower body are opened up along a second direction to take on the second body status in the second operation mode.

15. The portable electronic device as claimed in claim 14, wherein the first direction is substantially perpendicular to the second direction.

16. The portable electronic device as claimed in claim 10, wherein the first light source has a first pattern corresponding to the first input symbol, and the second light source has a second pattern corresponding to the second input symbol.

17. The portable electronic device as claimed in claim 10, wherein the key has a third pattern, a fourth pattern and a bottom, and the third pattern and the fourth pattern, corresponding to the first input symbol and the second input symbol, respectively, are disposed on the bottom.

18. The portable electronic device as claimed in claim 10, wherein the color of the first colored light is different from the color of the second colored light.

19. The portable electronic device as claimed in claim 10, wherein the first input symbol is one of a numeral, an English letter, a phonetic notation, a punctuation mark, and a sign, and the second input symbol is one of a numeral, an English letter, a phonetic notation, a punctuation mark, and a sign, and the first input symbol is different from the second input symbol.

20. The portable electronic device as claimed in claim 10, wherein each of the first light source and the second light source is one of an EL film and an OEL film.
